(19) United States
(12) Patent Application Publication
(10) Pub. No.: US 2013/0016863 A1
(43) Pub. Date: Jan. 17, 2013

(54) LOUDSPEAKER STRUCTURE FOR FLAT DISPLAY

(71) Applicants: Chun-ming Liu, New Taipei City (TW); Bo-min Weng, New Taipei City (TW)

(72) Inventors: Chun-ming Liu, New Taipei City (TW); Bo-min Weng, New Taipei City (TW)

(73) Assignee: HANNSTAR DISPLAY CORPORATION, New Taipei City (TW)

(21) Appl. No.: 13/411,659

(22) Filed: Mar. 5, 2012

(30) Foreign Application Priority Data
Jul. 11, 2011 (TW) 100124537

(51) Int. Cl. H04R 1/02

(52) U.S. Cl. 381/333

(57) ABSTRACT

A loudspeaker structure for a flat display comprises a shield structure and a speaker driver. The shield structure is formed by integratedly extending a front frame and a rear case which are used to assemble the flat display. The shield structure and the speaker driver surround or confine a space and are used to construct a speaker box for the loudspeaker. The present invention utilizes the front frame and the rear case to be integratedly extended to form the speak box and in such manner that the cost for equipping the flat display with the loudspeaker can be reduced and audio performance can be improved as well.

### TECHNICAL FIELD OF THE INVENTION

The present invention relates to a loudspeaker structure for a flat display, and more particularly, to a loudspeaker structure of a flat display which utilizes a front frame and a rear case of the flat display to be integrated extended to from a shield structure and utilizes the shield structure to form a speaker box.

### BACKGROUND OF THE INVENTION

Among current flat display products, some have built-in loudspeaker systems for satisfying the needs of audio-visual equipments. Among these displays having built-in loudspeaker systems, some will not equip speaker drivers with speaker boxes in order to reduce the cost while some high-end products will provide assemblies of the speaker drivers and the speaker boxes. That is, a high-end display is equipped with not only a speaker driver but also a speaker box designed according to the speaker driver.

The audio performance for the display products having the speaker drivers equipped therewith but without the speaker boxes is certainly much worse than that of loudspeakers having the speaker boxes. However, the display products having the speaker boxes equipped therewith cost too much. Therefore, how to develop a display product equipped with a speaker box in low cost is an importance issue in this industrial field.

### SUMMARY OF THE INVENTION

An objective of the present invention is to provide a loudspeaker structure for a flat display for reducing the cost of equipping a display product with loudspeaker and improving audio performance as well.

To achieve the above objective, the present invention is to provide a loudspeaker structure for a flat display, comprising: a front frame and a rear case which are assembled together; a first trench formed by integratedly extending from an inner surface of the front frame, the first trench has a first opening at one side and has a second opening opposite to the first opening; a speaker driver fastened into the first trench, the speaker driver seals the first opening of the first trench; and a second trench formed by integratedly extending from an inner surface of the rear case, the second trench has a third opening, the second opening of the first trench and the third opening of the second trench are overlapped, the first trench, the second trench, and the speaker driver confine a space and construct a speaker box as well.

In another aspect, the present invention provides a loudspeaker structure for a flat display, comprising: a front frame and a rear case which are assembled together; a shield structure which comprises an opening, and also comprises a plurality of walls that are extended upright from an inner surface of the front frame and the rear case and are integrated with the front frame and the rear case; and a speaker driver fastened into the shield structure, the speaker driver comprises a diaphragm which seals the opening of the shield structure and is appeared at the opening, wherein the walls of the shield structure and the speaker driver confine a space and construct a speaker box as well.

As compared to a display equipped with a speaker driver without having a speaker box, the present invention can improve audio performance for the display product with relatively low cost since the present invention utilizes the front frame and the rear case of the flat display to be integratedly extended from the inner surface thereof to form the shield structure, and the speaker box are formed by the shield structure and the speaker driver. As compared to a display equipped with a speaker box, the present invention also can reduce the cost efficiently since the speaker box is formed by the front frame 10 and the rear case 20 of the display.

### BRIEF DESCRIPTION OF THE DRAWINGS

FIG. 1 is a front view of a flat display.

FIG. 2 is a side view of a flat display.

FIG. 3 is an exploded view of a loudspeaker structure of a flat display of the present invention.

FIG. 4 is an enlarged view of the loudspeaker structure shown in FIG. 3.

FIG. 5 is a schematic diagram showing an assembled flat display.

FIG. 6 is a schematic diagram showing the loudspeaker structure shown in

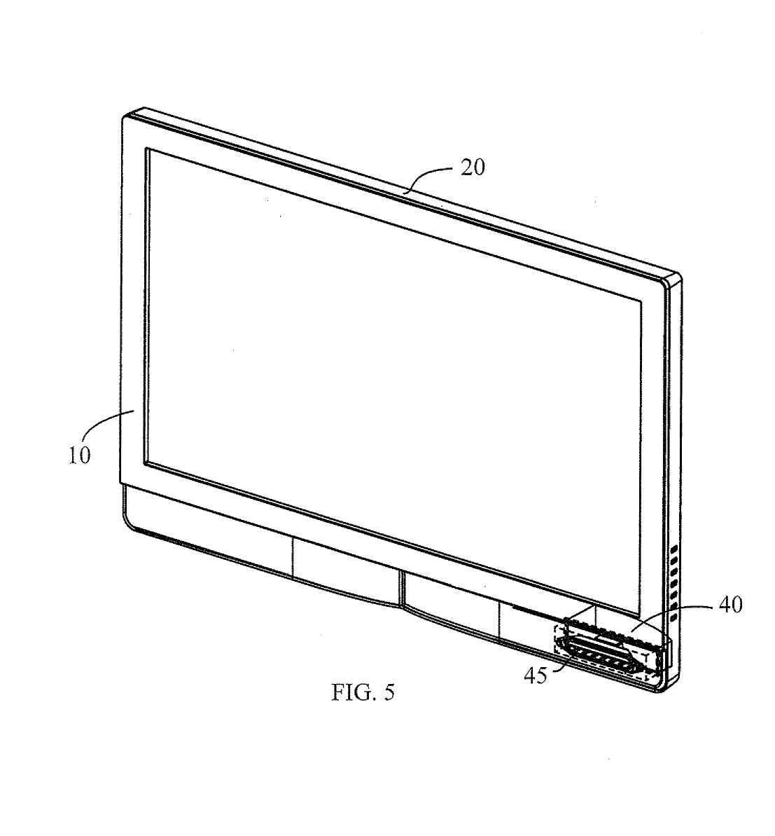

FIG. 5.

### DETAILED DESCRIPTION OF THE INVENTION

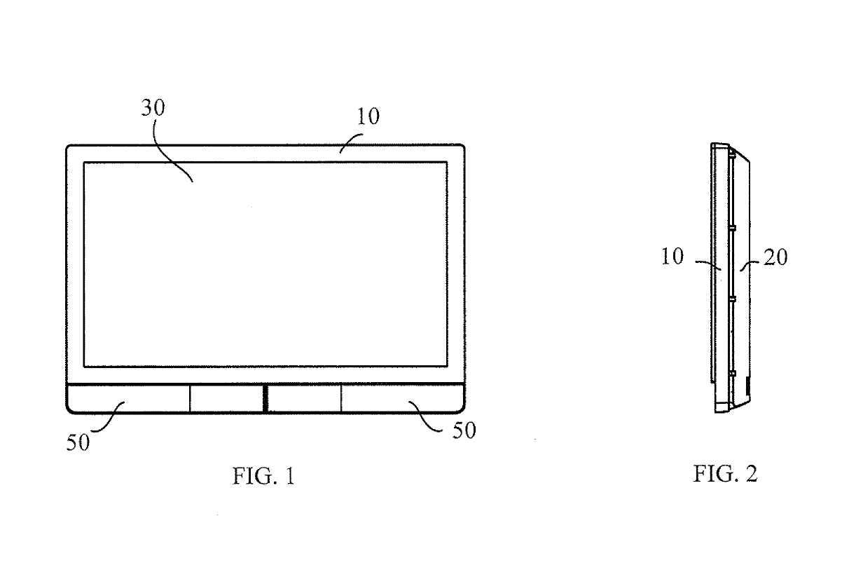

In the present invention, a front frame and a rear case used for assembling a flat display are extended integratedly to form a speaker box of a loudspeaker. In such a manner, audio performance of a display product (e.g., a flat panel television) equipped with such a loudspeaker can be improved. Referring to FIG. 1 and FIG. 2, the flat display generally comprises a display panel 30 and a backlight module (not shown). When assembling the flat display, a front frame 10 is often used to encompass and bind edges of the display panel 30, leaving a display area of the display panel 30 exposed. In addition, a rear case 20 is used to cover the backlight module and an inner circuit board (not shown) is fastened thereto. The front frame 10 and the rear case 20 are also used for assembling the display panel 30 with other inner elements (e.g., the backlight module and the circuit board) in the flat display. Loudspeakers 50 can be arranged at upper right and upper left sides, middle right and middle left sides, or lower right and lower left sides of the flat display, or their appropriate positions. In the present invention, the flat display may comprise a liquid crystal display (LCD), an organic light emitted diode display (OLED display), a plasma display panel (PDP), a field emission display (FED), and so on.

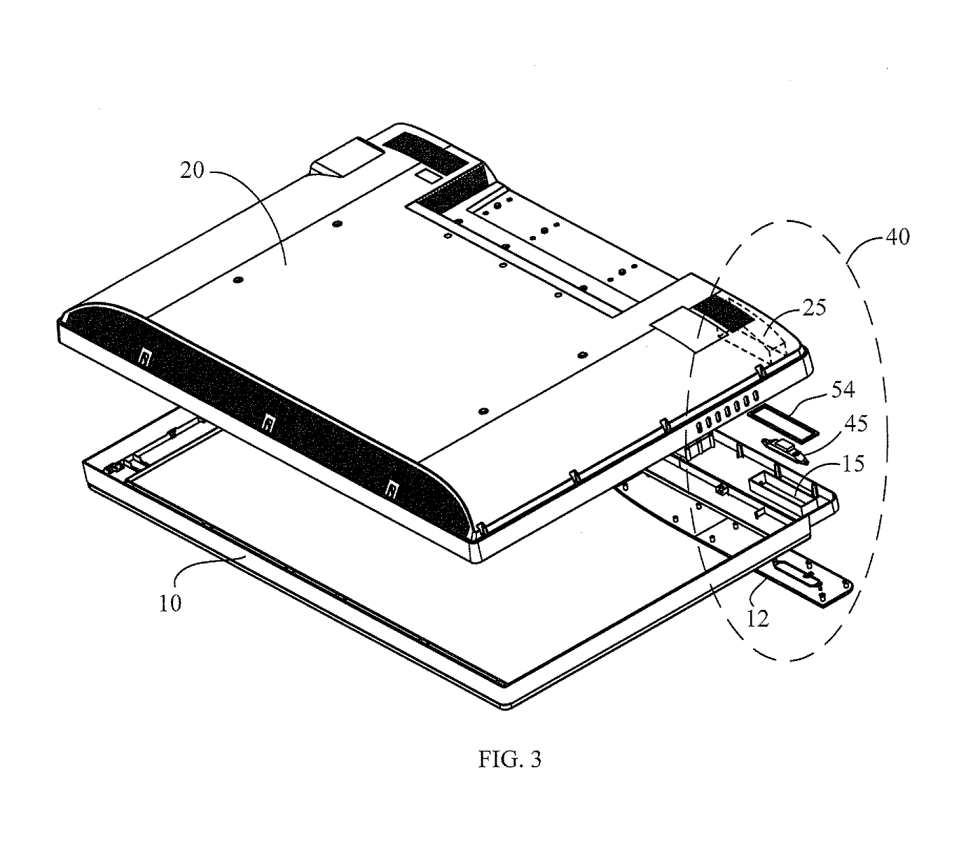

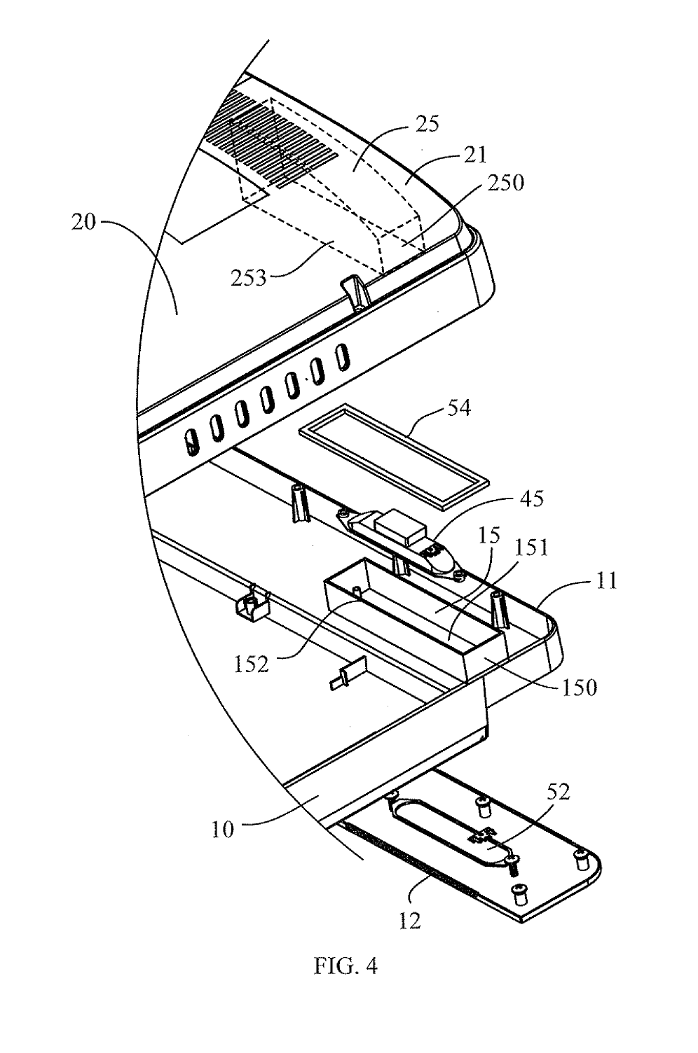

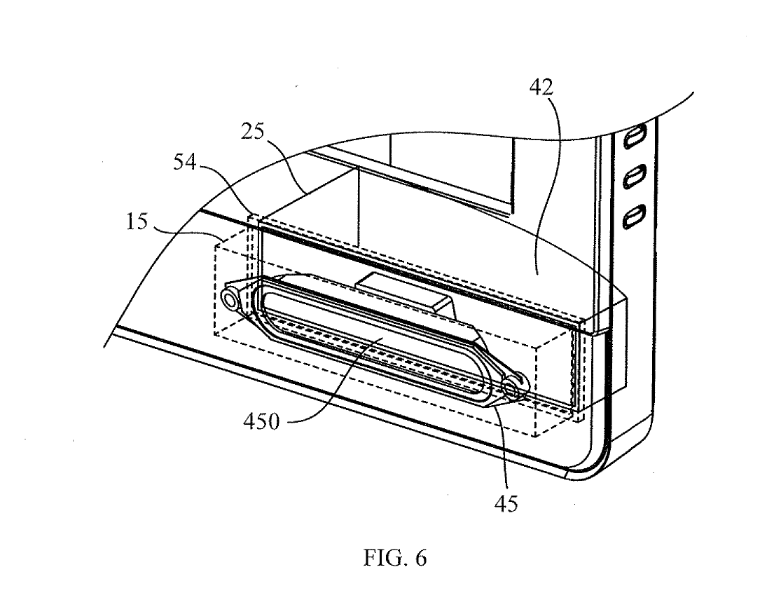

Please refer to FIG. 3 to FIG. 6. FIG. 3 is an exploded view of the loudspeaker structure of the flat display of the present invention. FIG. 4 is an enlarged view of the loudspeaker structure shown in FIG. 3. FIG. 5 and FIG. 6 are schematic diagrams respectively showing an assembled flat display and an assembled loudspeaker structure of the present invention. The loudspeaker structure 40 of the flat display of the present invention comprises a shield structure 42 and a speaker driver 45. The shield structure 42 is formed by integratedly extending the front frame 10 and the rear case 20. The shield structure 42 and the speaker driver 45 surround or confine a space and construct the speaker box as well. That is to say, the present invention utilizes the material or constituents of the front frame 10 and the rear case 20 to form the speaker box. In such a manner, the manufacturing cost of loudspeaker can be reduced and audio performance is improved as well. In one example, the shield structure 42 comprises at least one opening and a plurality of walls which are extended upright (or vertically) from an inner surface of the front frame 10 and the rear case 20. The speaker driver 45 is fastened into the shield structure 42 through the opening. A diaphragm 450 of the speaker driver 45 is disposed corresponding to the opening. The diaphragm 450 seals the opening but will be appeared at the opening of the front frame 10. That is, the diaphragm 450 is not entirely enclosed by the front frame 10. Therefore, the sound generated by vibrating the diaphragm 450 can be propagated in a direction leaving the front frame 10. The walls of the shield structure 45 and the speaker driver 45 confine a space and construct the speaker box. Also, the sound generated by vibrating the diaphragm 450 will resonate through the speaker box.

As described above, the present invention utilizes the front frame 10 and the rear case 20 of the flat display to be integratedly extended to form the speaker box during the manufacturing process. As shown in FIG. 3 and FIG. 4, the loudspeaker 40 of the flat display of the present invention comprises a first trench 15, the speaker driver 45, and a second trench 25. The first trench 15 and the second trench 25 form the shield structure 42 shown in FIG. 6. The first trench 15 is formed by integratedly extending from the inner surface of the front frame 10. Specifically, the first trench 15 comprises a plurality of first walls 150 which are extended upright (or vertically) from the inner surface of the front frame 10 and are integrated with the front frame 10. The second trench 25 is formed by integratedly extending from the inner surface of the rear case 20. Specifically, the second trench 25 comprises a plurality of second walls 250 which are extended upright from the inner surface of the rear case 20 and are integrated with the rear case 20. In concrete implementation phase, the front frame 10 is formed by plastic stamping or punching and the first trench 15 is formed together with a main body 11 of the front frame 10 during the plastic stamping process. Accordingly, the first trench 15 and the front frame 10 are made of the same material. Similarly, the rear case 20 is formed by plastic stamping or punching and the second trench 25 is formed together with a main body 21 of the rear case 20 during the plastic stamping process. Accordingly, the second trench 25 and the rear case 20 are made of the same material.

The first trench 15 formed by integratedly extending from the inner surface of the front frame 10 has a first opening 151 at one side and has a second opening 152 at another side or at an opposite side. The speaker driver 45 is placed into the first trench 15 and is fastened thereto. For example, screws or bolts are used for fastening the speaker driver 45 such that the speaker driver 45 seals the first opening 151 of the first trench 15. Specifically, the speaker driver 45 comprises the diaphragm 450 which are used to generate a sound by vibration. The diaphragm 450 faces the first opening 151 when placing the speaker driver 45 into the first trench 15. In such a manner, the diaphragm 450 completely seals the first opening 151 after the speaker driver 45 is fastened. As above, the diaphragm 45 is disposed corresponding to the first opening 151 of the first trench 15. After the front frame 10 and the rear case 20 are assembled together, the diaphragm 450 of the speaker driver 45 will be appeared at the first opening 151 of the front frame 10. That is, the diaphragm 450 is not entirely enclosed by the front frame 10 such that the sound generated by vibrating the diaphragm 450 can be propagated in a direction leaving the front frame 10.

The second trench 25 formed by integratedly extending from the inner surface of the rear case 20 has a third opening 253. The third opening 253 of the second trench 25 and the second opening 152 of the first trench 15 are of the same size. When assembling the front frame 10 and the rear case 20, the third opening 253 of the second trench 25 will be overlapped with the second opening 152 of the first trench 15. In such a manner, the first trench 15, the second trench 25, and the speaker driver 45 confine a space and construct the speaker box. The sound generated by vibrating the diaphragm 450 of the speaker driver 45 will resonate in the speaker box formed by the first trench 15 and the second trench 25, and thereby improving audio performance. In one embodiment, the first trench 15 and the second trench 25 can be implemented by those trenches substantially having a rectangular shape, but the present invention is not limited thereto. The first trench 15 and the second trench 25 also can be implemented by those trenches substantially having a circular or elliptical shape, or other shapes.

To make sure the speaker box can be functioning stably, the loudspeaker structure 40 of the flat display of the present invention further comprises a gasket ring 54 which is disposed between the second opening 152 of the first trench 15 and the third opening 253 of the second trench 25. The shape and size of the gasket ring 54 are designed according to the second opening 152 and the third opening 253. In addition, the gasket ring 54 can be made of a material having flexibility and resistance, such as rubber. The function of the gasket ring 54 is to make sure the first trench 15 and the second trench 25 are engaged closely and prevent from a leak. In another aspect, the gasket ring 52 is also used to absorb a part of vibration generated from the speaker box, and thereby the vibration propagating to the whole display can be reduced and the images displayed on a screen of the display would not affected thereafter.

In addition, the flat display comprises an assembling board 12 which is assembled to the front frame 10. The assembling board 12 is used to shield or protect inner circuits or elements and make the display appear smooth and beauty. The assembling board 12 has a hole 52 disposed corresponding to the first opening 151 of the first trench 15. The sound generated by the diaphragm 450 of the speaker driver 45 can be spread out through the hole 52. In addition, the assembling board 12 also can be designed to have a mask (not shown) arranged corresponding to the hole 52 for decoration and/or safety reasons.

Furthermore, the speaker box of the loudspeaker structure 40 of the present invention is basically airtight. That is, the afore-said space surrounded or confined by the first trench 15, the second trench 25, and the speaker driver 45 is basically airtight. However, other embodiments intend to alter the tone and therefore drill to form a hole at a particular position of the speaker box. Such designs should be deemed as included in the realm of the present invention.

Above all, in the present invention, the inner surface of the front frame 10 and the rear frame 20 of the flat display is integratedly extended to form the respective walls 150, 250 of the first trench 15 and the second trench 25 of the shield structure 42. The walls 150, 250 of the shield structure 42 and the speaker driver 45 confine a space and are used to construct the speaker box. As compared to a display equipped with a speaker driver without having a speaker box, the present invention can improve the audio performance for the display product with relatively low cost. As compared to a display equipped with a speaker box, the present invention also can reduce the cost efficiently since the speaker box is formed by the front frame 10 and the rear case 20 of the display.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A loudspeaker structure for a flat display, comprising:
a front frame and a rear case which are assembled together;
a first trench formed by integratedly extending from an inner surface of the front frame, the first trench has a first opening at one side and has a second opening opposite to the first opening;
a speaker driver fastened into the first trench, the speaker driver seals the first opening of the first trench; and
a second trench formed by integratedly extending from an inner surface of the rear case, the second trench has a third opening, the second opening of the first trench and the third opening of the second trench are overlapped, the first trench, the second trench, and the speaker driver confine a space and construct a speaker box as well.

2. The structure according to claim 1, wherein the first trench comprises a plurality of first walls which are extended upright from the inner surface of the front frame and are integrated with the front frame.

3. The structure according to claim 1, wherein the second trench comprises a plurality of second walls which are extended upright from the inner surface of the rear case and are integrated with the rear case.

4. The structure according to claim 1, wherein the first trench is integrated with the front frame, the first trench and the front frame are made of the same material.

5. The structure according to claim 1, wherein the second trench is integrated with the rear case, the second trench and the rear case are made of the same material.

6. The structure according to claim 1, wherein the speaker driver comprises a diaphragm which is disposed corresponding to the first opening of the first trench, the diaphragm is appeared at the first opening of the front frame.

7. The structure according to claim 1, further comprising a gasket ring which is disposed between the second opening of the first trench and the third opening of the second trench.

8. The structure according to claim 7, wherein a material of the gasket ring comprises rubber.

9. The structure according to claim 1, wherein the speaker box is airtight.

10. The structure according to claim 1, wherein the second opening of the first trench and the third opening of the second trench are of the same size.

11. The structure according to claim 1, wherein the first trench and the second trench are rectangular in shape.

12. The structure according to claim 1, further comprising an assembling board which is assembled to the front frame, the assembling board has a hole corresponding to the first opening of the first trench.

13. A loudspeaker structure for a flat display, comprising:
a front frame and a rear case which are assembled together;
a shield structure which comprises an opening, and also comprises a plurality of walls that are extended upright from an inner surface of the front frame and the rear case and are integrated with the front frame and the rear case; and
a speaker driver fastened into the shield structure, the speaker driver comprises a diaphragm which seals the opening of the shield structure and is appeared at the opening, wherein the walls of the shield structure and the speaker driver confine a space and construct a speaker box as well.
